(19) United States
(12) Patent Application Publication
(10) Pub. No.: US 2005/0093832 A1
(43) Pub. Date: May 5, 2005

(54) Mail system and mail service

(75) Inventors: Naohiro Furukawa, Hachioji (JP); Hisashi Ikeda, Kunitachi (JP); Hiroshi Sako, Shiki (JP); Yosuke Kato, Tokyo (JP)

Correspondence Address: Stanley P. Fisher;Reed Smith LLP, 3110 Fairview Park Drive, Suite 1400, Falls Church, VA, 20042-4503, US

(73) Assignee: Hitachi, Ltd

(21) Appl. No.: 10/766,208

(22) Filed: Jan. 29, 2004

(30) Foreign Application Priority Data
Nov. 5, 2003 (JP) 2003-375094

(51) Int. Cl. G09G 5/00

(52) U.S. Cl. 345/173

(57) ABSTRACT

A mail system for executing a mail service has a user management part for managing the information that the user previously registered, and a unit for utilizing the registered information as the destination of mails, so that the addresses of recipients can be efficiently managed. The sender acquires an address card that has printed with a pattern linking with the information of recipients. This address card is used when the sender writes a mail, and thus it serves to reduce the load on the sending operation. If a pattern linking with usage history information is printed on the mail, it also reduces the burden on the reply operation in which the recipient sends a reply back to the sender. The use of this usage history information for grasping the usage serves to efficiently adjust and calculate the cost for the service.

### BACKGROUND OF THE INVENTION

The present invention relates to a mail system and mail service for delivering mail matters such as messages and small packages.

Even in these days on which the electronics industry has been developed, mail is still one of the tools of communication. A report of “Society for the Surveillance Study on Mail Service in multimedia age” of Posts and Telecommunications Ministry, Mar. 27, 1997, says that mail is means of best carrying “polite feeling (48.4%)” and “most heartful feeling (41.1%). However, it also says that mail has demerits of low convenience such as “spirit of innovation” (0.6%), “immediate communication” (1.2%), “portability” (4.0%), “instantaneous delivery” (8.2%) and “simplicity” (11.3%). In order to eliminate those demerits, a hybrid mail service, for example, is offered in which the messages produced on a computer by a sender are transmitted through Internet or the like to a mail service company, printed in the company and then delivered as a printed matter to a specified recipient (“Swedish Post-“digilogue” postcards”, XMS Inc., searched on Oct. 31, 2003, Internet <URL: http://www.anotes.com/anoto/cases.html>).

The above hybrid mail service, however, treats no mail matter that includes handwritten letters, and thus it loses the original advantage of mail such as “polite feeling”.

Recently, an digital pen has been devised by which the pen strokes written on paper can be electronically read in. The digital pen disclosed in, for example, International Publication No. WO 01/71473 has a camera provided at the pen tip to pick up a pattern printed on paper so as to detect the pen tip position, and it records the history of the detected pen tip position to detect the pen strokes. We think that this type of digital pen will be widely used more than ever in the future.

### SUMMARY OF THE INVENTION

As the digital pen is widely used, realization of the hybrid mail service using the digital pen becomes important to eliminate the demerits of mail without the original advantage of mail. Thus, it is the first object of the invention to provide means for efficiently managing and using the addresses of recipients so that the mail matters can be smoothly delivered.

It is the second object of the invention to facilitate the transmitting operation from the standpoint of improving the convenience on the sender who sends a mail.

It is the third object of the invention to facilitate the reply operation to the sender from the standpoint of improving the convenience on the recipient who receives the mail.

It is the fourth object of the invention to provide means for managing service bills so that the bills can be effectively collected.

It is the fifth object of the invention to provide security means for preventing the digital pen from being falsely used when stolen.

In addition, it is the sixth object of the invention to improve the precision of the character recognition, which is important in order that the stroke data written in by the digital pen can be converted to text data, thereby making the mail service more efficient.

In order to achieve the first object of the invention, according to this invention, a user management part for managing information previously registered by the user is provided in the mail system for the mail service so that the registered information can be used as mail address, and therefore that the addresses of recipients can be effectively managed. In addition, when the user who previously registered the address uses the mail service, a using point is issued for added value such as discount, which promotes the user registration.

In order to achieve the second object, an address card having a pattern printed in association with recipient information is provided and used by the sender when the sender writes information on a mail, thus serving to reduce the sending-operation load on the sender.

In order to achieve the third object, a pattern associated with the usage history information is printed on the mail so that the address of the original sender can be extracted, thus serving to reduce the reply-operation load on the recipient.

In order to achieve the fourth object, usage history information for seeing the usage of the user is stored in the mail system, and used when an account is closed, so that the bill can be efficiently adjusted and charged.

In order to achieve the fifth object, the user previously registers a pen ID and signature for identifying the user, and when the user uses the mail service, signature authentication of if the pen ID and signature information coincide is performed to prevent the mail service from being falsely used.

In order to achieve the sixth object, character strokes failed to recognize in character recognition operation are collected, and correct character codes are assigned to those failed character strokes and used for the additional learning, thereby improving the precision of the character recognition.

Thus, this invention has an effect that the mail service company side can manage the address information of the user and efficiently deliver the mail. Even if the user changes his or her place of residence, the user applies for registration change, and thus the address can be updated. In addition, the transport cost can be reduced because of omitting the operations for taking charge of and sending the mail and for the transport of mail from the taking-charge office to the delivery office.

From the standpoint of the sender for sending the mail, the information of the recipient and sender is not necessary to be written in each time because of the previous registration, and the user does not need to bring the mail to the mail post or pickup center. Therefore, the mail sending operation can be simplified. In addition, when the sender sends the address card to the recipient, the sender does not need to know the address of the recipient. If the recipient changed his place of residence, the sender could send a mail just to the recipient even without knowing the address of the new residence as long as the recipient applied for the renewal of the address card. This is a great merit for the sender.

Under the condition that the user has finished the user registration, the recipient for receiving the mail can simply make the reply operation to the mail. In addition, there is a merit that the mail can be delivered to the sender to which the address card has been distributed without informing of his or her each address change. Moreover, since only name is printed on the address card, it is convenient that the recipient can receive the mail even if the recipient does not inform the sender about address information when the recipient does not want to inform of his or her address. Also, since the pen ID and signature authentication identify the sender, the recipient can surely reject to receive the mail from specified senders. In addition, since the E-mail can detect the transmission of mail in advance, the recipient can confirm the mails received after a long-distance trip or long-time absence. Furthermore, the time when the mail arrives at the recipient can be specified.

Thus, according to the invention, the service company, the sender and the recipient can expect many advantages associated with the mail service.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the processing between relevant parties that appear in the invention.

FIG. 2 is a diagram to which reference is made in explaining the principle of the digital pen used in the embodiments of the invention.

FIG. 3 is a diagram showing a user registration form used in the embodiments of the invention.

FIG. 4 is a diagram showing the address card used in the embodiments of the invention.

FIG. 5 is a diagram showing a mail form used in the embodiments of the invention.

FIG. 6 is a diagram showing the front face of a post card used in the embodiments of the invention.

FIG. 7 is a diagram showing the rear face of the post card used in the embodiments of the invention.

FIG. 8 is a diagram showing a reply message written on the rear face of the post card used in the embodiments of the invention.

FIG. 9 is a flowchart for the mail sending operations according to the invention.

FIG. 10 is a flowchart for the user registration operations according to the invention.

FIG. 11 is a flowchart for the acceptance of mails.

FIG. 12 is a flowchart for the user registration.

FIG. 13 is a diagram showing the data structure of stroke information.

FIG. 14 is a diagram showing the data structure of the user information and usage history information.

FIG. 15 is a diagram showing the construction of a mail system according to the invention.

FIG. 16 is a diagram showing the modes in which the digital pens and the mail system used in the embodiments of the invention are connected.

### DESCRIPTION OF THE EMBODIMENTS

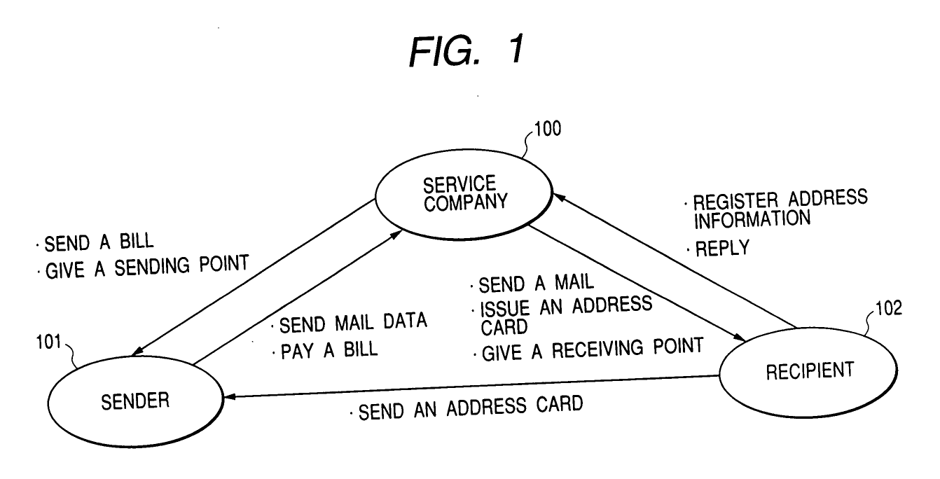

The related parties of the embodiments of the invention will first be described. Three relevant parties can be considered as illustrated in FIG. 1.

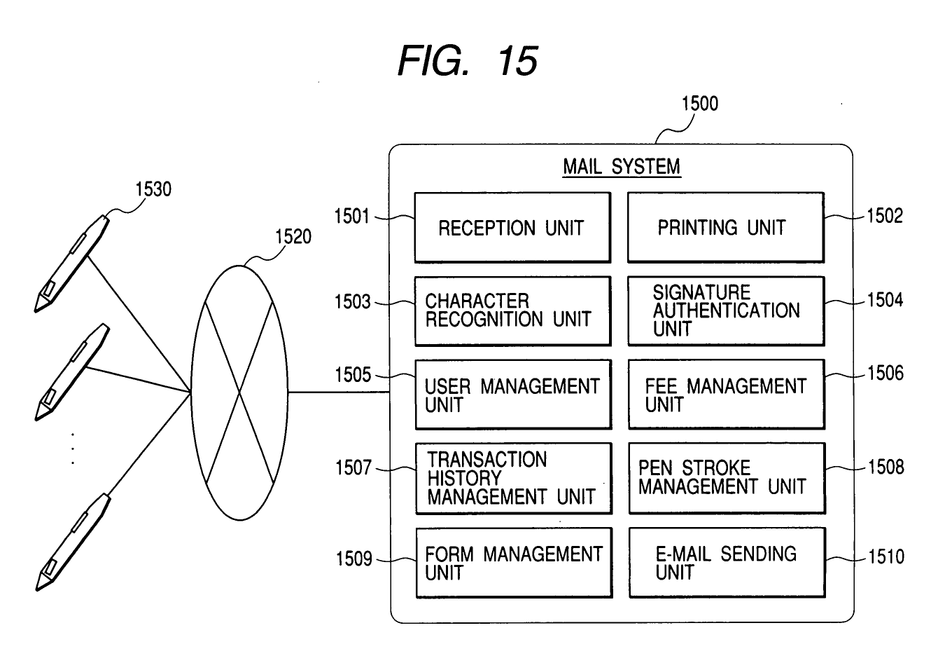

The first concerned party is a service company 100 that actually operates mail service. The service company has a mail system for the operation of mail service (FIG. 15).

The second party is a sender 101 who sends a mail matter by use of the mail service that the service company operates. The sender needs to previously register personal information such as pen ID, name and address in the mail service, or make user's registration.

The third party is a recipient 102 who finally receives the mail matter that the sender transmitted. The recipient does not always need to previously register in the mail service. Even the recipient who does not register yet can receive a hybrid mail from the sender as well as he or she receives the regular mail. However, if the recipient previously makes user's registration, such advantages can be offered that (1) the sender can easily make an entry of recipient's address when sending a mail, (2) the recipient can easily send a reply to the sender and (3) a receiving point is given when the mail is simply received.

The senders and recipients who registered to the mail service are generally called the mail service user or simply user. The user has an digital pen with which the user makes an entry of necessary information on a mail and sends the mail. The user who does not have the digital pen can also have a right to behave as a recipient of mail according to the invention, if registering information other than pen ID.

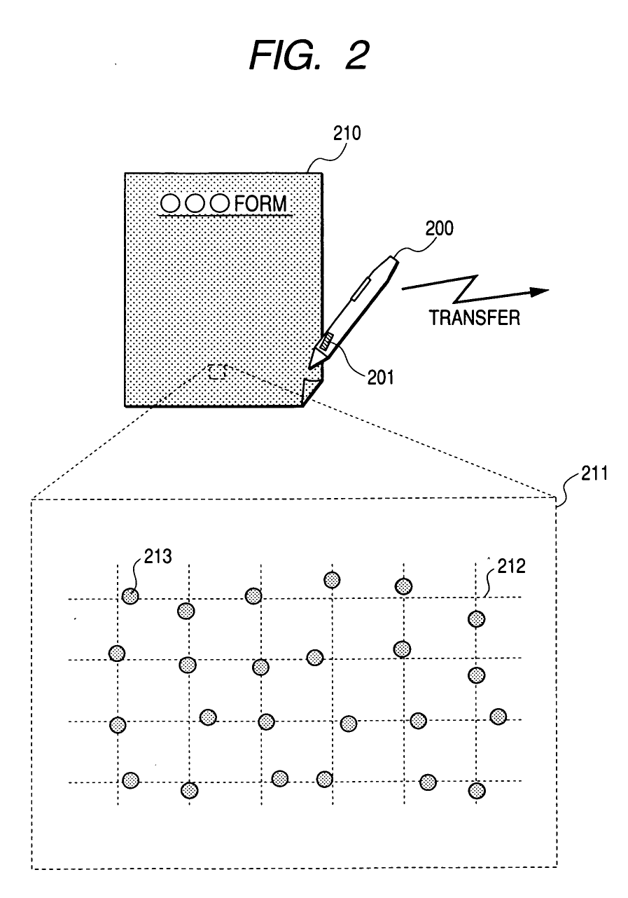

Here, the digital pen disclosed in the International Publication Brochure No. 01/71473 will be described as one example of the digital pen used in the embodiments of the invention (FIG. 2). Shown at 200 is an digital pen, and 201 a camera device that produces the image of a position-detecting pattern printed on a piece of paper 210. A magnified view 211 of part of the paper 210 shows small dots 213 inhomogeneously scattered about. These dots are certainly printed shifted by a certain distance either up, down, left or right away from the intersecting (regular) points of imaginary grid lines 212.

Absolute position information within a large-area plane region can be acquired by simultaneously referring to an area of a plurality of dots, for example, 6×6, and using the combinations of the shifted values of 36 dots up, down, left or right from the regular positions. In other words, when the camera 201 provided on the digital pen collects the image of the range including the plurality of dots at regular intervals of time, the position on the space can be detected by the combinations of shifted values. The details of this principle will be understood from the International Publication No. WO 01/71473. This digital pen has radio communication equipment for transmitting and receiving information of detected pen stroke, pen ID and so on. If this digital pen is applied to the mail service of the invention, the frame of mail form in which the user writes can be immediately detected. Therefore, there is a merit that the user does not need to explicitly transmit information of kind of mail form. Accordingly, this digital pen system can be said to be one system suited for the hybrid mail service, and thus embodiments in which this digital pen system is used will be mentioned below. However, other systems than this digital pen system may be used if they can detect the information of written contents and form, and transfer it to the mail system.

FIG. 15 shows the construction of a mail system used in an embodiment of the invention. The mail system 1500 has a reception part 1501 for accepting a mail transmission request from the sender, a printing part 1502 for printing a mail, a character recognition part 1503 for converting stroke information to a character code, a signature authentication part 1504 for preventing the pen from being unjustly used, a user management part 1505 for managing personal information such as user's address, a fee management part 1506 for computing and managing service fee to user, a transaction history management part 1507 for recording the interchange of mails, and a pen stroke management part 1508 for managing stroke information written in with the digital pen. This mail system further includes a form management part 1509 for managing forms used in the mail system, and an E-mail sending part 1510 for transmitting E-mails to users who desire to receive delivery completion information of mail through E-mail. In addition, the mail system 1500 is connected through a network 1520 to one or a plurality of digital pens 1530. All the functions included in the mail system 1500 are not necessarily provided in the same facility. For example, the personal information of all registered users may be collected at one place and managed. Each of a plurality of centers established over all area of mail service may take charge of part of the other functions. In this case, mails are accepted at the center nearest to the place where the sender has issued a mail transmission request, and mails are printed at the center closest to the address of the recipient, and then delivered, thus making it possible to reduce the burden placed upon the communication resources and delivery operations.

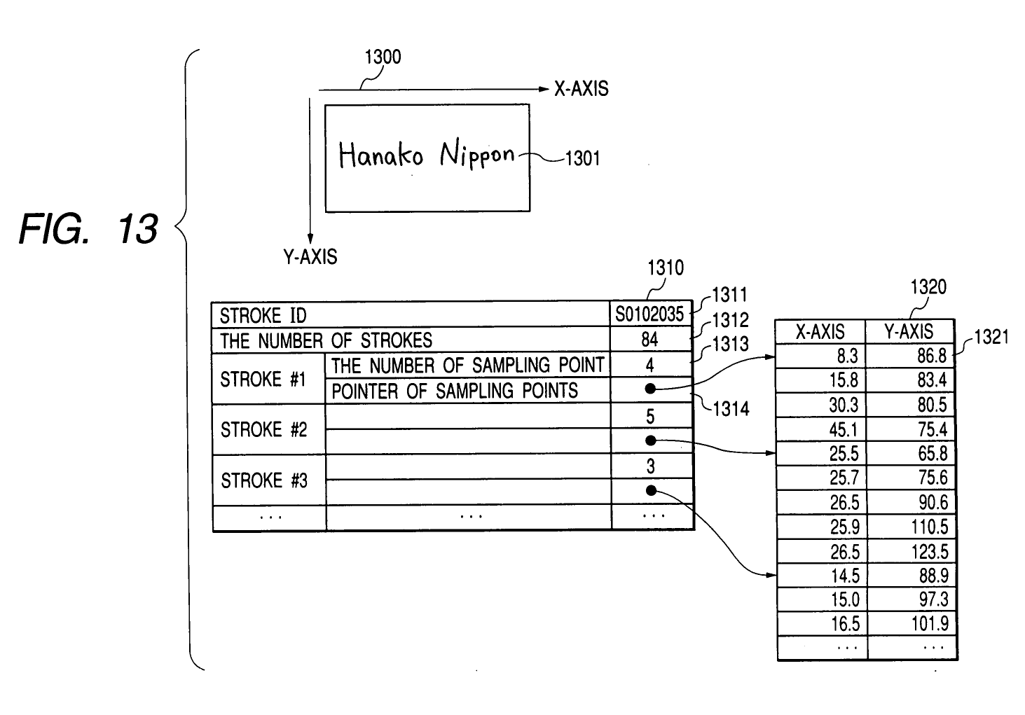

The stroke management part 1508 manages stroke information in the data structure shown in FIG. 13. The stroke information, 1310 has a stroke ID 1311, the number of all strokes 1312, the number of sampling points 1313 of each stroke, and a pointer 1314 to sampling points. The pointer to sampling points indicates one sample coordinates 1321 of sample point information 1320. The sampling point number 1313 of samples from the sample pointed by the pointer 1314 constitutes a sampling point array that indicates that stroke.

The form management part 1509 makes the following processing. The forms used in the mail system include a user registration form 300, an address card 400 and a mail form 500. Each of the forms has a different dot pattern printed depending on the kind of form. The form management part previously memorizes the dot patterns assigned to those forms. Thus, when a character is written in on a certain form with the digital pen, the pen stroke is detected, and at the same time the form on which the character has been written in and the position of the entry can be detected. The address card is specified to have a different dot pattern depending on each recipient. The dot pattern on each form may be different depending on each sender. In addition, all forms of the same kind may have different dot patterns, respectively or some of the forms may have different dot patterns so that the order of the current paper can be discriminated from others. Thus, the order of the current paper can be detected from a different dot pattern filled on the paper.

The mail system 1500 can be built up on hardware of an calculation unit for computing fee, and making character recognition and others, a storage unit such as hard disks for storing various data of user data and stroke data, communication equipment necessary for the connection to the network, and a printer for printing mails and address cards. To disperse the loads on the system and strengthen the system, the character recognition part 1503 and the other parts may be separately provided on different hardware units or the storage unit may be provided at a plurality of places.

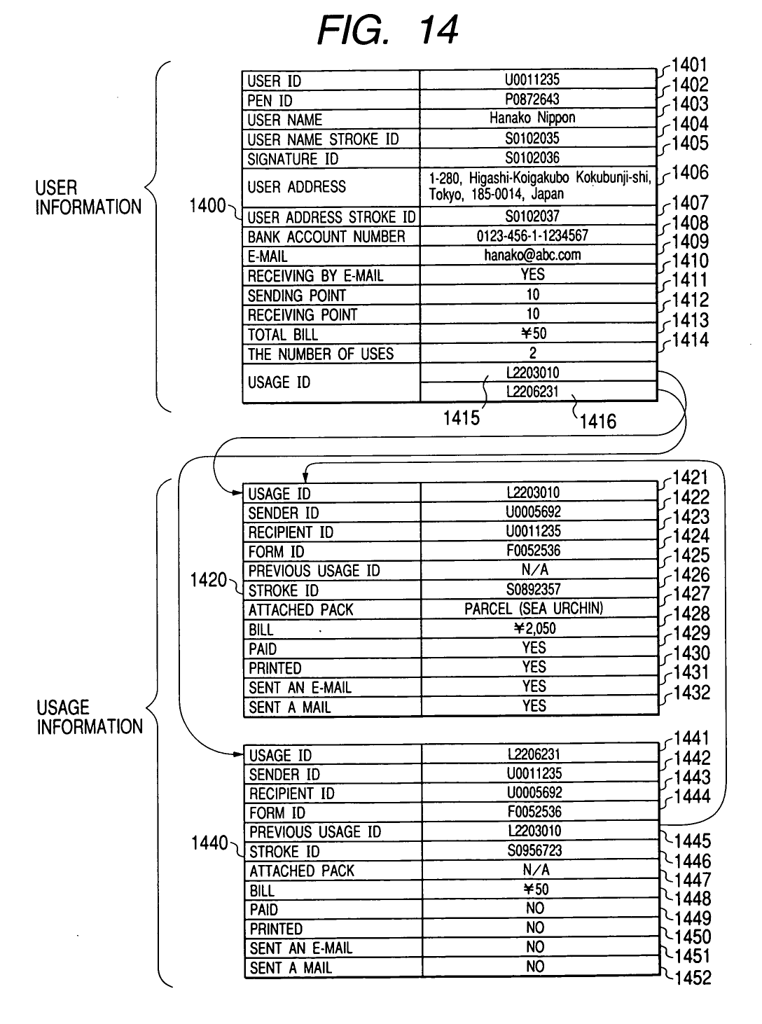

Moreover, the user information is managed in the data structure shown in FIG. 14 at 1400. The user information has a user ID 1401, a pen ID 1402 that the user uses, a name text 1403 of the user, a user name stroke ID 1404 written in user's own hand, a signature ID 1405, a user address 1406, a user address stroke ID 1407 written in user's own hand, a bank account number 1408 of user, an E-mail address 1409 of user, an intent 1410 of receiving by E-mail indicating whether the user desires mail delivery completion information by E-mail, a sending point 1411 issued from service company when the user has sent a mail, a receiving point 1412 issued from service company when the user has received a mail, a total bill 1413 to the user, the number of uses, 1414 indicating the number of times that the user has used so far, and a usage ID 1415˜1416 indicating the number of times that the user has so far used the service. The sending point and receiving point may be treated together as a using point or the total bill 1413 may be directly reduced as using point=discounting reduction.

The transaction, or usage history information is managed in a data structure shown in FIG. 14 at 1420. The usage history information has a usage ID 1421, a sender ID 1422, a recipient ID 1423, a form ID 1424, a previous usage ID 1425 indicating the ID of the usage at the time of reply to certain sending, a stroke ID 1426 of the written stroke information, an attached pack 1427 for storing the information when a pack is attached to the mail, a bill 1428, a paid flag 1429, a printed flag 1430, a sent E-mail flag 1431, and a sent mail flag 1432.

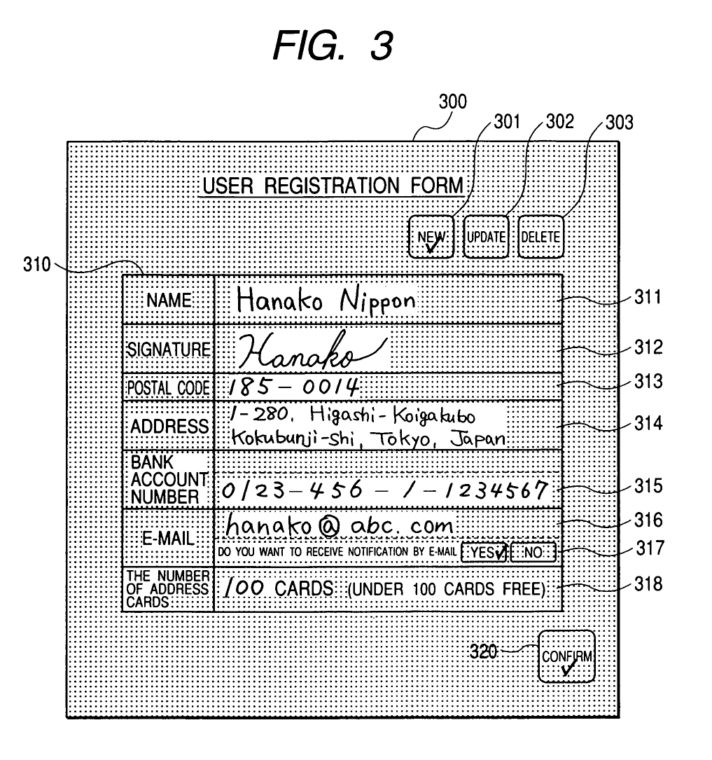

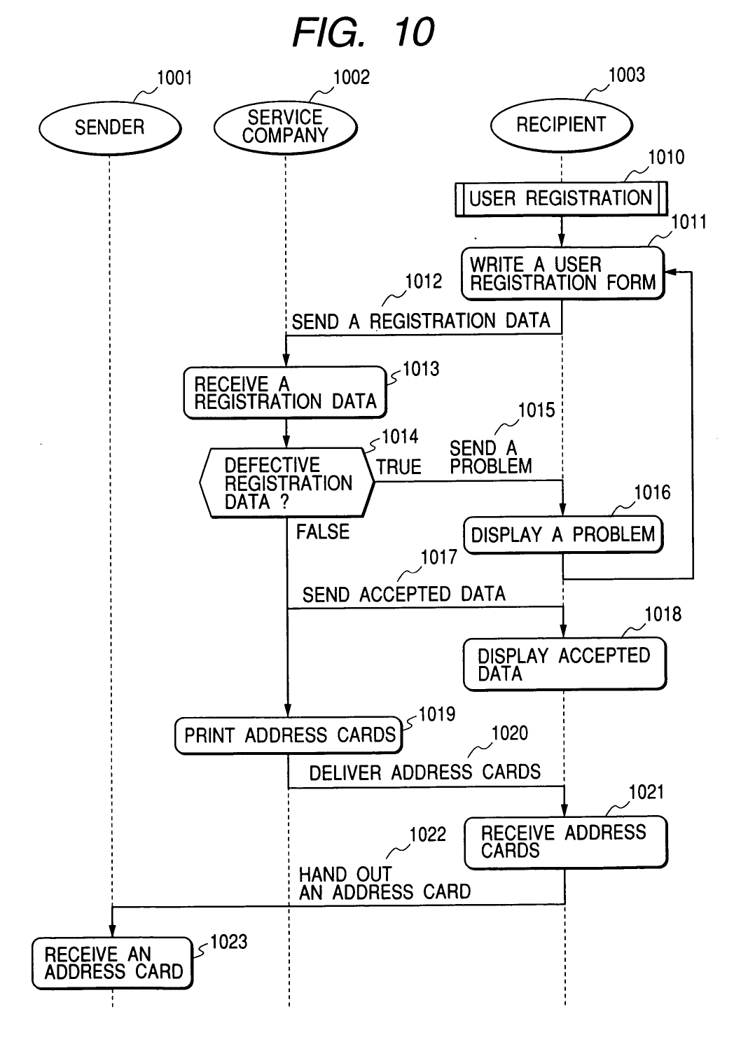

The procedure for processing the user registration will be described in detail. FIG. 10 is a flowchart showing the operation flow taken when a recipient 1003 makes user's registration. First, the recipient who desires the registration writes in necessary items on a user registration form (FIG. 3) by using an digital pen (step 1011). In this case, other forms than the form of paper and pen used as in FIG. 3 in this step may be used as, for example, a method of making an entry of necessary items on Web browser. However, the use of digital pen and paper shown in FIG. 3 will produce advantages of (1) automatic registration of information written by digital pen, (2) bulk registration of name, address and signature written in user's own hand, and (3) registration only by using the digital pen without PC or the like. Thus, in the following description, it is assumed that the embodiments of the invention take the registration procedure using the digital pen shown in FIG. 3.

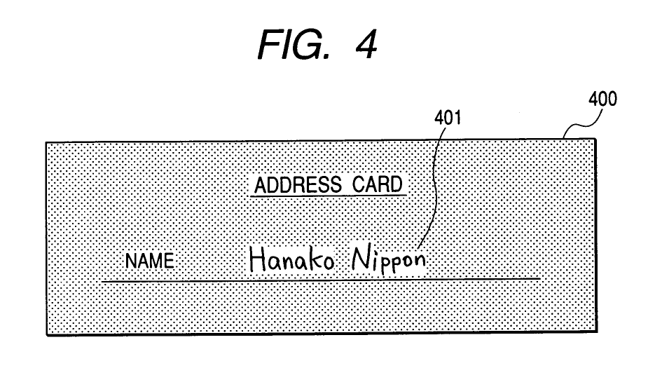

The items written in include, as shown in FIG. 3, application type (new 301, update 302 and delete 303), a name 311, a signature 312, a postal code 313, an address 314, a bank account number 315, an E-mail address 316, an intent 317 to desire a notice of mail to that address, and the number of address cards 318 desired to issue. These items are written in by using the digital pen. After confirmation of the filled contents, a check mark is filled in a confirmation box 320, triggering the transmission of the written registration information to the user management part 1505 (of FIG. 15) of the mail system of the service company (step 1012). Then, a user registration process 1013 is executed within the mail system. If there is defective registration data, a reason for the defective data is transmitted to and displayed on the recipient 1003 (steps 1014˜1016). The recipient corrects the contents according to the designated items, and makes reapplication. The details of the user registration process 1013 will be mentioned later. If there is not defective registration data, the fact that there is not defective registration data is transmitted to the recipient and displayed (steps 1017˜1018). The service company 1002 prints the address card 400 (FIG. 4) for the recipient who has applied for registration, and delivers the address card to the recipient (steps 1019˜1020). The address card 400 has printed thereon a name 401 of the user to be linked to the address card, and a pattern linked to the user information. The recipient who has received the address card (step 1021) sends the address card to the sender 1001 who desires his or her mail, and the sender receives that card (steps 1022˜1023). In another case, when the recipient 1003 applies for registration, the sender may be specified by the address, name or user's ID of the destination (sender 1001) of the address card, so that the service company can send the address card directly to the sender 1001. The sender uses the received address card when sending a mail, thus the transmission operation being made efficient.

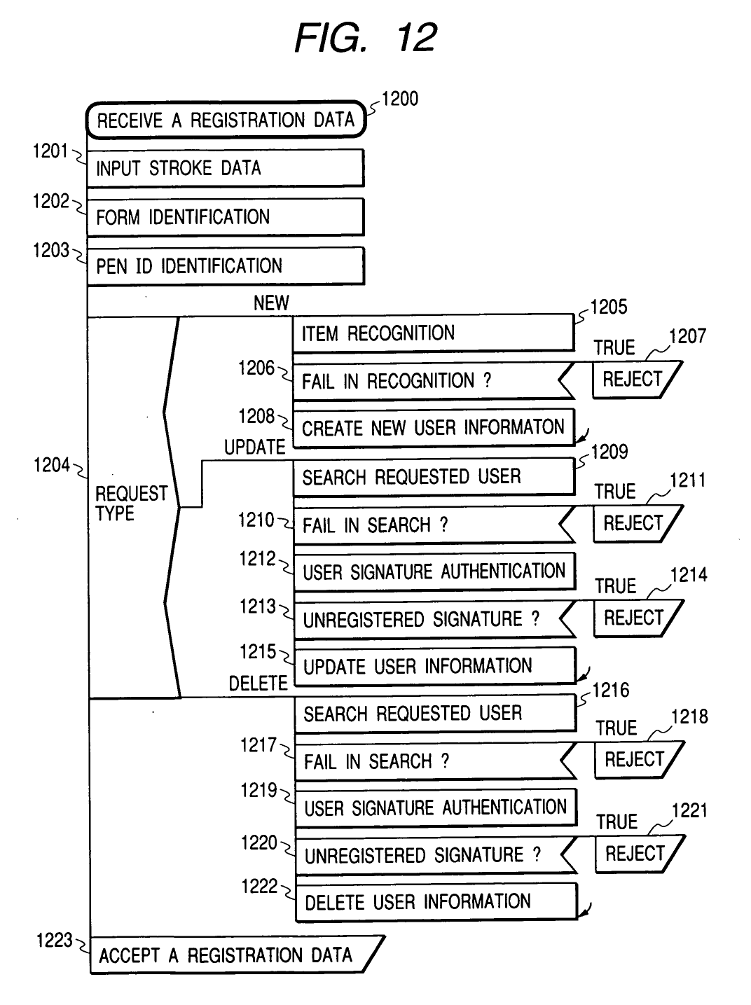

The user registration process 1013 will be described in detail (FIG. 12). In step 1201, stroke data is entered. The kind of the form written is identified from its coordinates (step 1202). In a pen ID identification step 1203, ID information is acquired from the pen. In step 1204, the request type is discriminated. If the type is “new”, the contents of the respective items are read out (steps 1205˜1207). In step 1208, the read-out results are newly registered as user information. When each item is read out, the stroke information of the items of written character trains such as name, address and bank account number is converted into a text by the character recognition part 1503 shown in FIG. 15. At this time, the human visually checks the written items that have failed to be converted by a video coding system (VCS). If the written item itself is false, a notice of wrong writing is sent to the user. If the written item is correct, a correct text is entered by use of VCS, and the character recognition part is forced to record this stroke information and text as a case of character recognition failure. Examples of such character recognition failure are accumulated and used for the additional study of the character recognition part, thereby making the character recognition part a more precise device.

If “update” is decided in the request type discrimination step 1204, the user information of the applicant is searched for according to the pen ID (steps 1209˜1211). If the corresponding information is detected, the signature authentication is performed to verify the applicant (steps 1212˜1214). If the signature is authenticated, the update request is decided to be from the applicant, and the registered contents are updated (step 1215).

If “delete” is decided in the request type discrimination step 1204, the user information of the applicant is searched for as in the update case (steps 1216˜1218). If there is the corresponding information, the signature authentication is made to confirm the applicant (steps 1219˜1221). If there is no problem in the authentication step, the delete request is decided to be from the applicant, and the registered contents are deleted (step 1222).

After the execution of the processes along each request type, the user registration is finally accepted (step 1223). The procedure for the user registration has been described above.

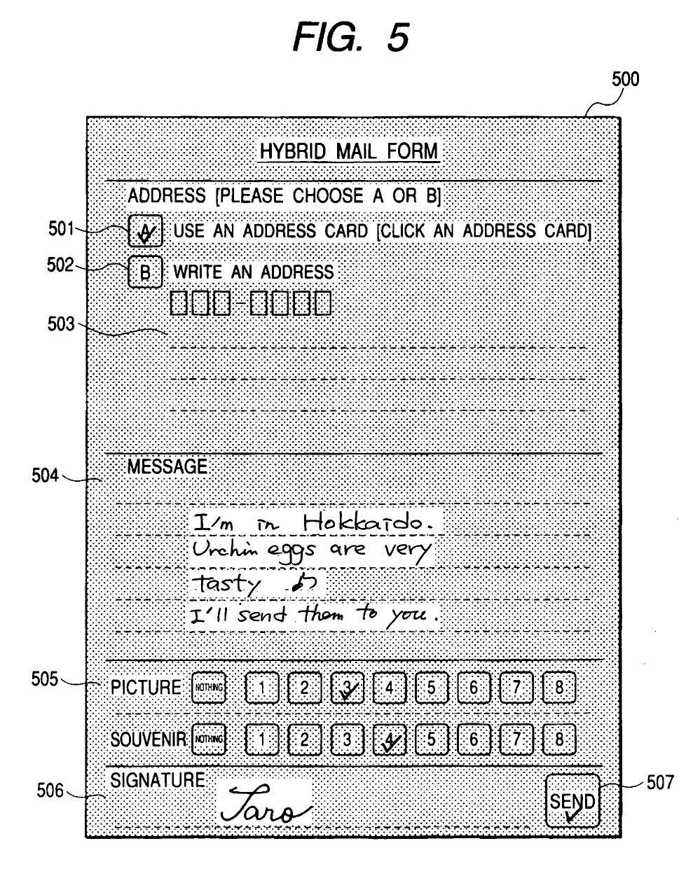

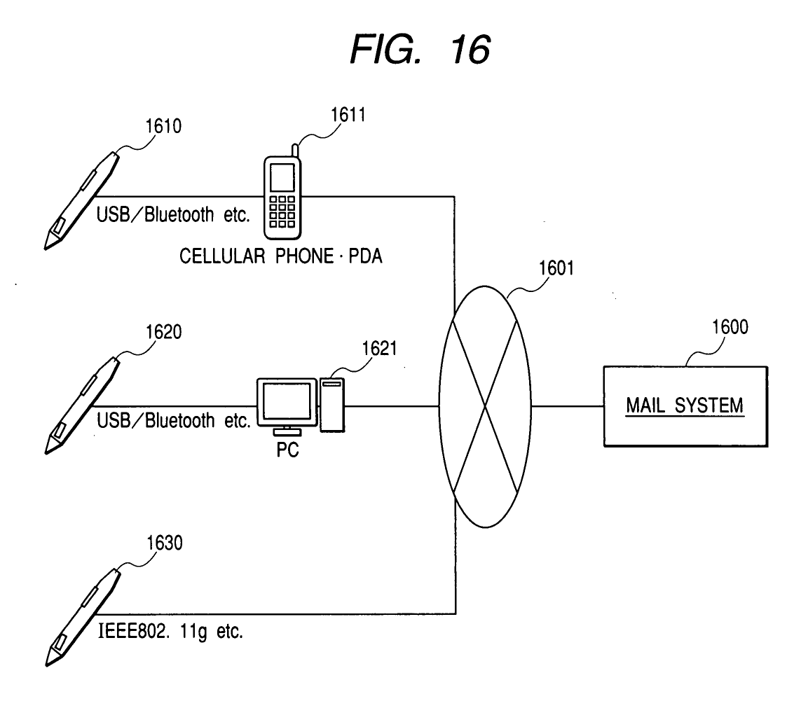

The procedure for the sender to send a mail to the recipient will be described in detail with reference to an example of the mail form shown in FIG. 5. First, the connection modes between the digital pen of the sender and the mail system will be mentioned (FIG. 16). The connection between the digital pen and the mail system takes either one of the following modes. (1) An digital pen 1610 is connected through a portable device terminal 1611 such as a cellure phone or PDA to a network 1601 so that it can communicate with a mail system 1600. (2) An digital pen 1620 is connected through a PC 1621 to the network 1601 so that it can communicate with the mail system 1600. (3) An digital pen 1630 is directly connected to the network 1601 so that it can communicate with the mail system 1600. The notice from the mail system is displayed on the portable device terminal, PC or digital pen. Therefore, in the case of mode (3), the digital pen needs to have a device for the direct connection to the network and another device such as a liquid crystal display on which the notice from the mail system is made known.

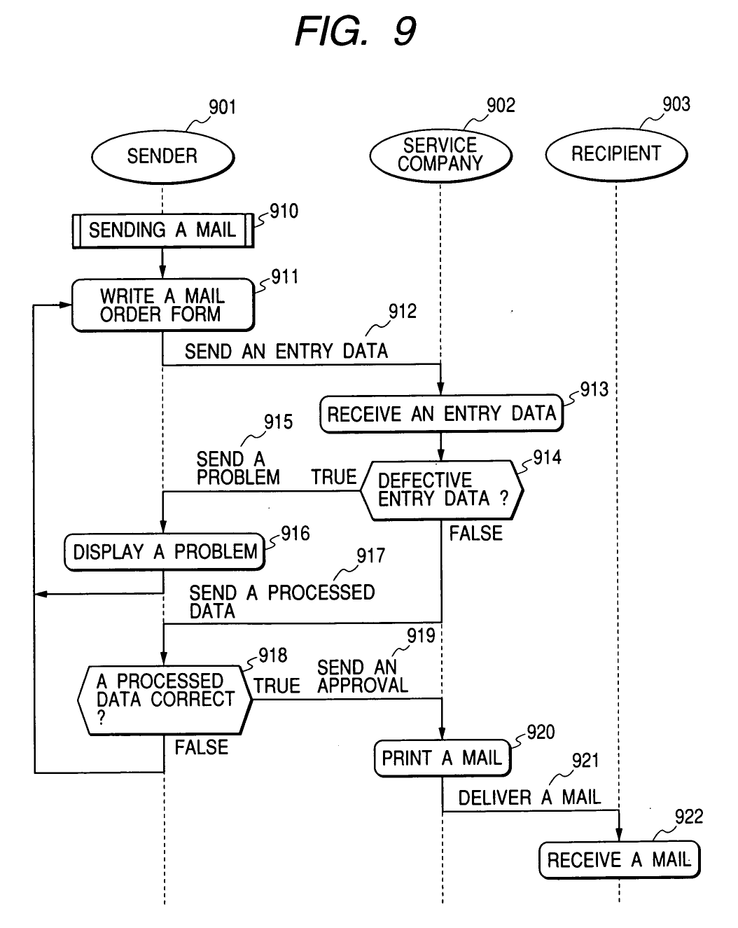

FIG. 9 shows a procedure for the operations of mail sending. A sender 901 uses an digital pen to write in necessary items on a mail order form shown in FIG. 5 (step 911). The option boxes 501˜502 are provided for deciding how to specify the address of the recipient. If the sender previously acquired the address card of the recipient, the sender chooses the box 501, and then writes a check mark at a predetermined place on the address card 400. This operation links the entry data of the mail form shown in FIG. 5 and the address information of the recipient. If the sender does not have address card of the recipient yet or if the recipient did not make the user registration for mail service at all, the sender selects the option box 502, and writes the address in a space 503 as in the normal mail. In this example, it is assumed that the address card can be previously acquired.

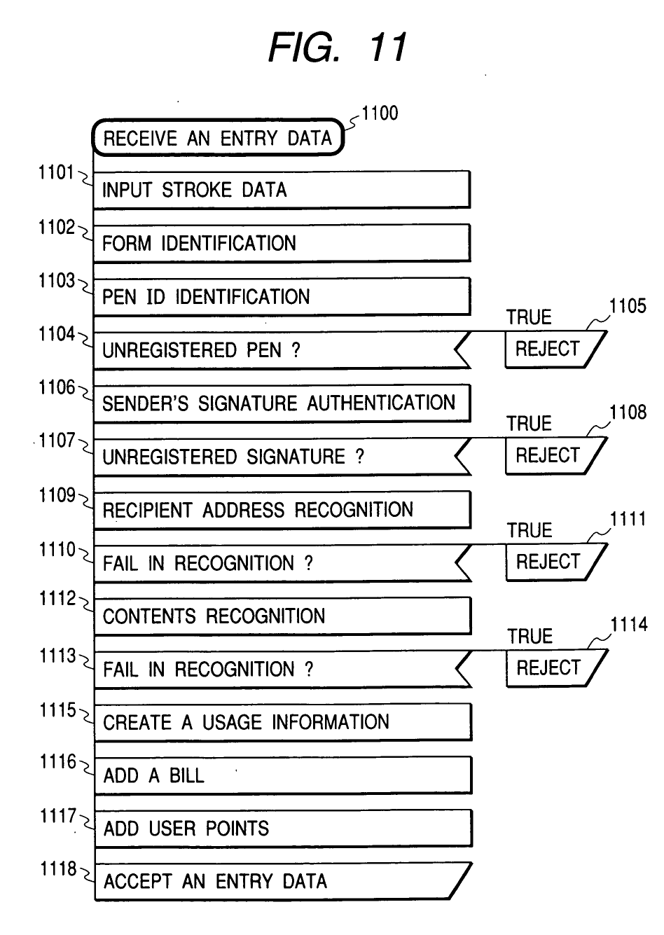

Then, a message that the sender wants to send to the recipient is filled in a correspondence column 504. The characters and figures written in this column are directly sent to the recipient. In the example of mail form shown in FIG. 5, option boxes 505 are also provided to select a picture on a post card, and a souvenir (from the offered list of souvenirs that the service company can acquire and deliver to the recipient) attached to the post card. In this example, it is assumed that an image of lakeside is selected as the picture and that a sea urchin is chosen as the souvenir. Finally, if it is confirmed that there is no error in the written contents, the sender signs his name in a signature block 506, and writes a check mark in a sending box 507 by the digital pen. The check mark written in the box triggers the transmission of the written mail-acceptance data to the mail system of the service company (step 912 in FIG. 9). A mail acceptance process 913 is executed on the written data transferred within the mail system. If there is any defective entry data, the fact that there is any defective entry data is transmitted to the sender where the data is displayed and rewritten (steps 914˜916). This mail acceptance process 913 will be further described in detail (FIG. 11). First in step 1101, the written stroke information is entered. The type of written form is identified from the coordinates (step 1102). Then, in a pen ID identification step 1103, the written pen-ID information is acquired. The ID of pen that the user registered (item 1402 in FIG. 14) is searched for according to that acquired pen ID (step 1104). If there is no registered pen ID, the mail is rejected (step 1105). If the written ID information coincides with the registered ID information, the signature 1405 written in the user information of the pen and the signature 506 written in the mail form are checked by the signature authentication part (1504 in FIG. 15) provided within the mail system. If it does not coincide with the registered signature, the mail is rejected (steps 1107˜1108). Then, when a recipient address recognition step 1109 is executed, the address information of the recipient is acquired. In this example, since the address card is used, the user ID of the recipient is computed from the pattern printed on the address card, and the address information corresponding to the items 1403˜1407 in FIG. 14 is extracted. In addition, each of contents (504˜505) of mail form 500 is recognized and the selected results of the picture and attached pack are obtained (steps 1112˜1114). In step 1115, the read results of the mail form are used to newly create usage history data, and the data is filled. Then, the total bill is computed (step 1116), and the using points of transmission and reception are added to the sender and recipient, respectively (step 1117). After the execution of the above processes, the mail is accepted (step 1118).

If it is accepted, the sender admits the acceptance (steps 917˜919). If the sender admits, the service company prints the mail (step 920), and delivers the mail (step 921), and the recipient receives the mail (step 922).

If the recipient wants to receive E-mail in addition to the mail (1410 in FIG. 14), the E-mail sending part (1510 in FIG. 15) provided within the mail system is used to send E-mail to the recipient when the mail is printed in step 920.

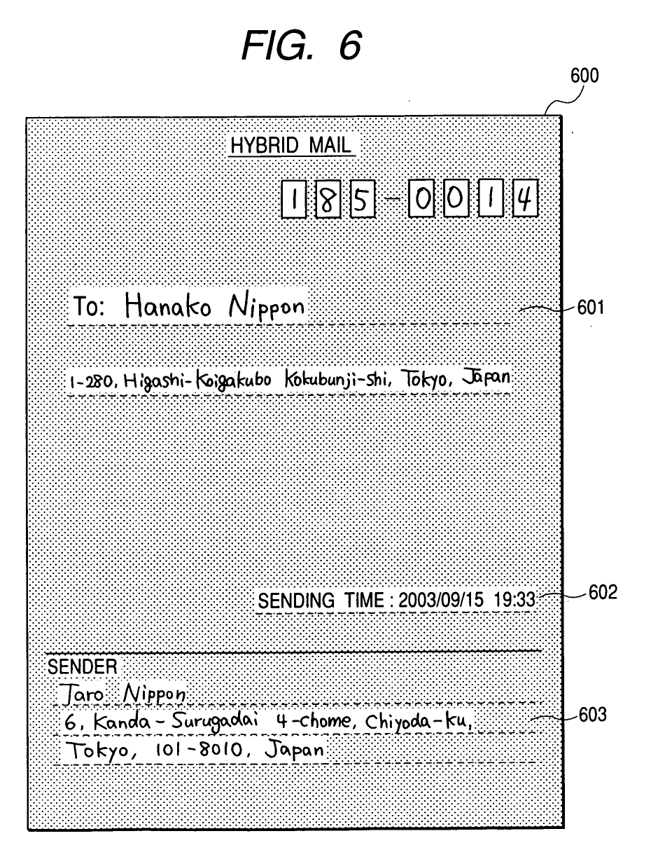

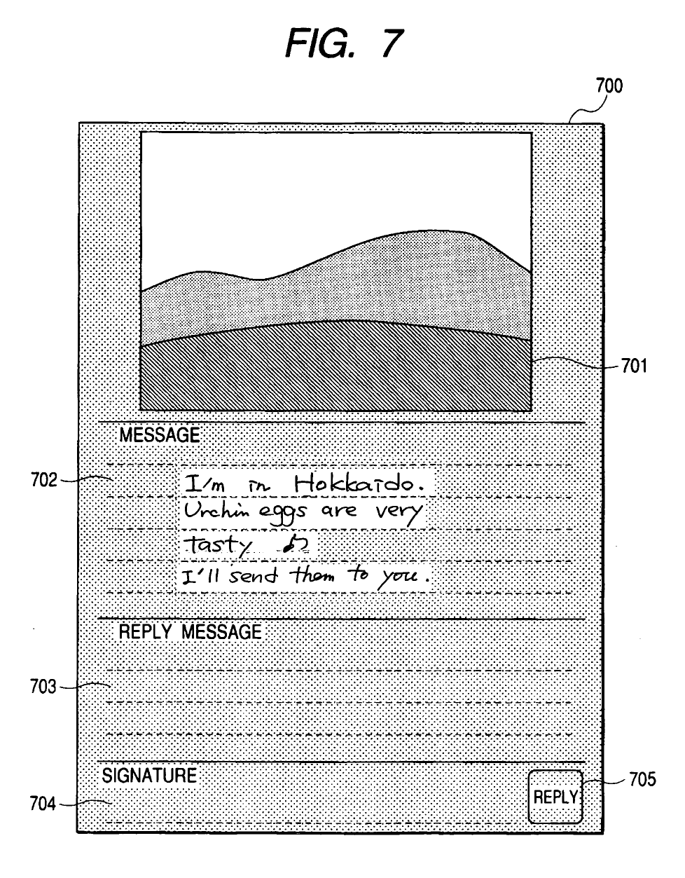

FIGS. 6 and 7 respectively show the printed images (on the front face and rear face) of the mail accepted by the above procedure. A post card 600 shown in FIG. 6 needs an address 601 of the recipient to be printed. This is because a delivery clerk of the service company finally delivers the mail or because it should be printed so that the human can read it. In addition, it is necessary to print an address 603 of the sender. The reason is that the recipient must know the sender who sent the mail. Moreover, a sending time 602 when the sender sent the mail will be good information for the recipient.

On the rear face (FIG. 7) of the post card are printed a picture 701 that is selected by option box 505 and a message 702 written in the correspondence column 504. Since the message written in sender's hand is printed as it is, “feeling of carrying the implication that the sender loves the recipient” can be transmitted which is the original merit of mail.

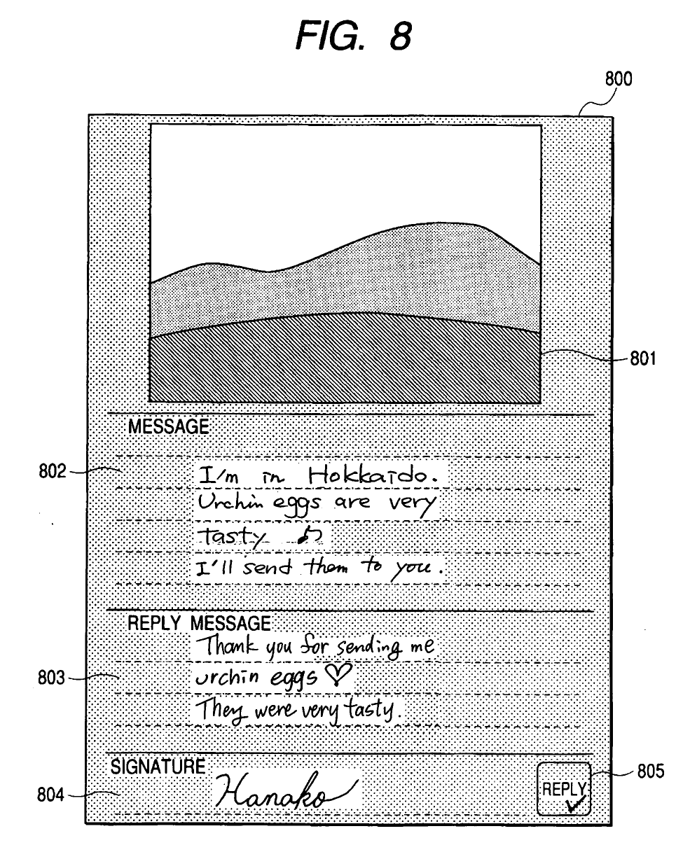

A pattern from which the digital pen can detect the position is previously printed on the mail. Thus, if the recipient previously made the user registration for the mail service, the reply can be readily sent to the sender by making an entry on the mail with the digital pen. 703˜705 in FIG. 7 designate fields for the reply. The message for the reply can be filled in the correspondence column 703, the signature of the recipient can be written in the signature block 704, and the reply box 705, when depressed, can send the reply. FIG. 8 shows an example of having actually made an entry of a reply message on the post card of FIG. 7. This image itself is sent from the recipient back to the sender, and delivered to the original sender.

The above description is about an embodiment of the invention.

Use of the digital pen will enable the user to utilize the mail service for delivering mails such as messages and small packs.

It should be further understood by those skilled in the art that although the foregoing description has been made on embodiments of the invention, the invention is not limited thereto and various changes and modifications may be made without departing from the spirit of the invention and the scope of the appended claims.

1. A mail system in which, when a sender enters information to send a mail using a digital pen, said digital pen detects the position of the tip of said pen from a pattern printed on the surface of a form for input, and as a result to detect the stroke of said pen, said mail system comprising:
a communication device for communication through a network;
an calculation unit; and
a printer,
said communication device accepting from said sender a mail-sending request with said input form written in by using said digital pen,
said mail-sending request including at least a mail message and pen stroke information that indicates the address of a recipient who receives said mail,
said calculation unit determining the destination of said mail-sending request on the basis of said pen stroke information that indicates said address included in said mail-sending request,
said printer printing said mail including character strings that indicate said mail message and said determined destination.

2. A mail system according to claim 1, further comprising:
a storage unit storing therein personal user information that includes at least a user name and associated pen ID of said sender who sends said mail,
said calculation unit identifying said sender of said mail on the basis of said pen ID sent from said digital pen,
said printer printing said identified user name of said sender on said mail.

3. A mail system according to claim 2, wherein said personal user information includes signature information previously registered, said mail-sending request includes a signature of said sender, said calculation unit performs authentication of said signature included in said mail-sending request by using said signature information included in said personal user information, and if said signature is authenticated, accepts said mail-sending request so that said printer prints said mail.

4. A mail system according to claim 1, further comprising:
a storage unit storing therein personal user information that includes destination address information of said recipient of said mail, wherein when said mail-sending request includes information input with an address card which is an digital pen input form associated with said personal user information of said recipient and which said sender has beforehand, said calculation unit searches for said personal user information on the basis of said input information of said address card to decide said destination address.

5. A mail system according to claim 1, further comprising:
a storage unit storing therein character recognition knowledge for character recognition based on said written pen stroke information,
said calculation unit processing said written address information of character strings to recognize said characters on the basis of said character recognition knowledge and to thereby determine said address.

6. A mail system according to claim 5, wherein said calculation unit collects the strokes of characters failed to be recognized in said character recognition processing, assigns correct character codes to said character strokes and thus makes use of those failures for additional learning about the function of said character recognition, thereby improving the accuracy of character recognition.

7. A mail system according to claim 1, further comprising:
a storage unit for storing therein personal user information that includes user names, addresses and pen ID information of said sender and said recipient who send and receive said mail, respectively,
said printer providing, by printing, a reply block in which reply information can be written by use of said digital pen while printing said mail to be sent from said sender to said recipient,
said communication device receiving a reply message that said recipient has filled in said reply block of said sent mail by use of said digital pen,
said printer printing said reply mail including said reply message.

8. A mail system according to claim 1, further comprising:
a storage unit storing therein personal user information that includes user ID information and service usage history information of said sender of said mail or said recipient of said mail,
said service usage history information including using point information that is issued on the basis of the use of service by said sender or said recipient,
said calculation unit computing a total bill for the mail service using said mail system according to said stored using point information.

9. A mail service providing method using a mail system that has an digital pen capable of detecting the position of the tip of said pen from a pattern printed on the surface of an input form and as a result detecting pen strokes, an calculation unit that communicates through a network to receive and accept a mail-sending request and a mail from a sender who has written in said input form by use of said digital pen, and a printer that prints said mail from said sender to produce said mail to a recipient on the basis of said acceptance in said calculation unit, wherein
said main-sending request includes at least said pen stroke information that indicate a mail message and the address of said recipient who receives said mail,
said calculation unit determines the address described in said mail-sending request on the basis of said pen stroke information indicating said address, and
said printer prints said mail including character strings that indicate said mail message and said determined address.

10. A mail service providing method according to claim 9, wherein said storage unit of said mail system has previously stored therein personal user information including at least a user name and associated pen ID of said sender who sends said mail,
said calculation unit identifies said sender of said mail by use of said pen ID transmitted from said digital pen, and
said printer prints the user name of said identified sender on said mail.

11. A mail service providing method according to claim 10, wherein said personal user information includes signature information previously registered, said mail-sending request includes the signature of said sender, and said calculation unit performs authentication of the signature included in said mail-sending request on the basis of the signature information included in said personal user information, and if the signature is authenticated, said calculation unit accepts said mail-sending request so that said mail can be printed.

12. A mail service providing method according to claim 9, wherein said storage unit included in said mail system stores previously therein personal user information that includes destination address information of said recipient who receives said mail, and when said mail-sending request includes information input with an address card which is said pen input form associated with the personal user information of said recipient and which said sender has beforehand, said personal user information is searched on the basis of input information of the address card so that said address can be determined.

13. A mail service providing method according to claim 9, wherein said storage unit included in said mail system stores therein character recognition knowledge for character recognition based on said written pen stroke information, and said character recognition knowledge is used to recognize the characters included in said written address information of character strings that indicate said address, and to thereby determine said address.

14. A mail service providing method according to claim 13, wherein strokes of characters failed to be recognized in said character recognition processing are collected, and correct character codes are assigned to said recognition-failed character strokes and used for additional learning of character recognition function, thus improving the accuracy of said character recognition.

15. A mail service providing method according to claim 9, further comprising the steps of:
storing in said storage unit included in said mail system personal user information including user names, addresses and pen ID information of said sender and said recipient who send and receive said mail, respectively;
printing a reply block on a pen input form so that reply information can be written therein by use of said digital pen while printing said mail to be sent from said sender to said recipient;
receiving a reply message in said reply block of said mail input by said recipient with said electronic pen; and
printing a reply mail including said replay message.

16. A mail service providing method according to claim 9, wherein said storage unit included in said mail system stores therein personal user information including user ID information and service usage history information of said sender of said mail or said recipient, said service usage history information includes using point information issued each time said sender or said recipient uses said mail service, and said calculation unit computes a total bill for the mail service using said mail system in accordance with said stored using point information.
